(19) United States
(12) Patent Application Publication
(10) Pub. No.: US 2012/0166303 A1
(43) Pub. Date: Jun. 28, 2012

(54) SYSTEMS AND METHODS FOR FACILITATING TRANSACTIONS BETWEEN SELLERS AND BUYERS

(75) Inventors: Stephen Peter Godwin, Winchester (GB); James Matthew Siddle, Winchester (GB)

(73) Assignee: INTERNATIONAL BUSINESS MACHINES CORPORATION, Armonk, NY (US)

(21) Appl. No.: 12/979,595

(22) Filed: Dec. 28, 2010

(51) Int. Cl. G06Q 30/00

(52) U.S. Cl. 705/26.7

(57) ABSTRACT

Described are systems and methods for facilitating an on-line transaction. An information item is received from an on-line location. The information item is related to an available item. A potential recipient of the available item is identified. The potential recipient is qualified for notification of the available item by determining a physical proximity between the available item and an offeror of the item. The potential recipient is qualified for notification of the available item by determining a relationship between the offeror of the item and the potential recipient. An electronic notification is generated for the qualified potential recipient in response to the physical proximity determination and the relationship determination.

### FIELD OF THE INVENTION

The invention relates generally to the field of commercial transactions, and more particularly, to systems and methods for facilitating an online transaction.

### BACKGROUND

On-line commercial transaction services, for example, an Ebay® on-line auction, offer an electronic marketplace where buyers and sellers can arrange to exchange commercial goods, personal and real property, services, or other items of value. A typical on-line transaction operates where a seller lists an item on a website of an intermediary, such as an electronic marketplace, and one or more potential buyers place a bid on the item. Generally, the buyer who submits the highest bid is permitted to purchase the item. In some cases, the first buyer willing to pay the seller's price is permitted to purchase the item. Other on-line transactions occur when a seller communicates directly with an interested party, for example, a potential buyer, by contacting his social network connections, without any facilitation by an intermediary. Such on-line services attempt to attract potential buyers by listing an item for sale on a website and by offering search tools to potential buyers for locating items of interest.

### BRIEF SUMMARY

According to one embodiment of the invention, a computer-implemented method for facilitating an on-line transaction is provided. An information item is received from an on-line location. The information item is related to an available item. A potential recipient of the available item is identified. The potential recipient is qualified for notification of the available item by determining a physical proximity between the available item and an offeror of the item. The potential recipient is qualified for notification of the available item by determining a relationship between the offeror of the item and the potential recipient. An electronic notification is generated for the qualified potential recipient in response to the physical proximity determination and the relationship determination.

According to another embodiment of the invention, a transaction facilitator comprises an item locator, a buyer identifier, and a notification module. The item locator receives an information item from an on-line location, the information item related to an available item. The buyer identifier identifies a potential recipient of the available item. The buyer identifier further qualifies the potential recipient for notification of the available item by determining a physical proximity between the available item and an offeror of the item and by determining a relationship between the offeror of the item and the potential recipient. The notification module generates an electronic notification for the qualified potential recipient in response to the physical proximity determination and the relationship determination.

According to another embodiment of the invention, a computer-implemented method for facilitating an on-line transaction is provided. An item for availability is identified from an electronic marketplace. A list of potential recipients of the available item is identified. The potential recipient and a social network are compared to determine a relationship between the potential recipient and an offeror of the item. The list of potential recipients is modified in response to comparing the potential recipient and the social network. A notification is generated to at least one of the modified list of potential recipients and the offeror of the available item.

According to another embodiment of the invention, a computer program product is provided for notification of availability of an item. The computer program product comprises a computer readable storage medium having computer readable program code embodied therewith. The computer readable program code comprises computer readable program code configured to receive an information item from an on-line location. The information item is related to an available item. The computer readable program code comprises computer readable program code configured to identify a potential recipient of the available item. The computer readable program code comprises computer readable program code configured to qualify the potential recipient for notification of the available item by determining a physical proximity between the available item and an offeror of the available item. The computer readable program code comprises computer readable program code configured to qualify the potential recipient for notification of the available item by determining a social proximity between the offeror of the item and the potential recipient. The computer readable program code comprises computer readable program code configured to generate an electronic notification for the qualified potential recipient in response to the physical proximity determination and the social proximity determination.

### BRIEF DESCRIPTION OF THE DRAWINGS

The above and further advantages of this invention may be better understood by referring to the following description in conjunction with the accompanying drawings, in which like numerals indicate like structural elements and features in the various figures. The drawings are not necessarily to scale, emphasis instead being placed upon illustrating the principles of the invention.

FIG. 1 is a network diagram illustrating an environment in which embodiments of the systems and methods according to the inventive concepts can be applied.

FIG. 2 is a block diagram of an embodiment of the transaction facilitator shown in FIG. 1.

FIG. 3 is a flowchart of an embodiment of a method for facilitating an on-line transaction between a buyer and a seller.

FIG. 4 is a flowchart of an embodiment of another method for facilitating an on-line transaction between a buyer and a seller.

FIG. 5 is a schematic block diagram illustrating an example of an embodiment of a process flow of a transaction facilitator.

FIG. 6A is a screenshot illustrating an example of an embodiment of a notification to a potential buyer of an item for purchase.

FIG. 6B is a screenshot illustrating an example of an embodiment of a notification to a seller of an item.

### DETAILED DESCRIPTION

In the following description, specific details are set forth although it should be appreciated by one of ordinary skill that the present invention can be practiced without at least some of the details. In some instances, known features or processes are not described in detail so as not to obscure the present invention.

In brief overview, the present invention features a system and method for facilitating on-line transactions between buyers and sellers. The online transactions that are implemented with the embodiments described herein may involve the purchase or other exchange of items of value such as goods and/or services over the Internet. An item of value is identified, for example, from an e-commerce website and/or an electronic marketplace. Item information such as item location and delivery options can also be provided. One or more potential buyers are identified as candidates for entering into a transaction with the seller by querying electronic commerce websites, electronic marketplaces, or other on-line sources. The potential buyers are vetted by determining if the potential buyers are in close proximity to the item of interest, if the potential buyers have a social relationship with the seller, and/or if the potential buyers have a known interest in the item or similar items, for example, by recording their interest in an e-commerce wish list or notification service. If the potential buyer is determined to be a qualified potential buyer based on one or more of these criteria, the potential buyer receives a notification of the availability of the item. For example, if a user records her interest in the item with an e-commerce wish list, the user can be notified when the item on her wish list becomes available in her local area from a seller she has a relationship with. The seller can also receive a notification that a potential buyer is interested in acquiring the item for sale. The seller and/or potential buyer can engage in a transaction based on information in the notification such as location information, social relationship details, and/or buyer interest information.

Accordingly, the present invention combines on-line trade services, social networking services, e-commerce wish list, recommendation services, advertisements, and/or other on-line services, which can increase the likelihood that a transaction will take place between a buyer and a seller. For example, a local transaction can take place, allowing personal social knowledge and local community knowledge to play a part in the transaction. These features can overcome conventional e-commerce challenges, where potential buyers must often perform an exhaustive time-consuming Internet search for an item, occasionally resulting in failure to find the item of interest, or where a transaction fails to take place because the buyer discovers that the item, for example, an automobile, is located too far away from the buyer for the buyer to take delivery at the item's location.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

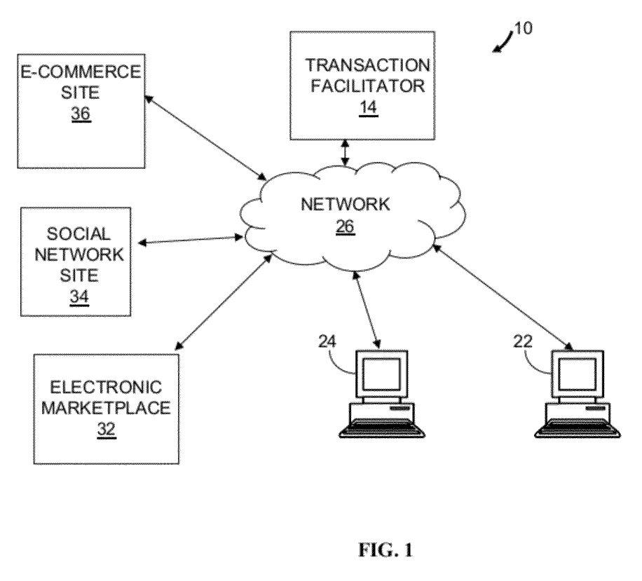

FIG. 1 is a network diagram illustrating an environment 10 in which systems and methods according to the inventive concepts can be practiced.

A transaction facilitator 14 communicates with an electronic marketplace 32, a social network service 34, and/or an e-commerce website 36 via a network 26. The network 26 can be a communications network such as the Internet, or other communications network known to those of ordinary skill in the art as being capable of transmitting data, voice, video, or a combination thereof. The transaction facilitator 14 can include a single server, or can include distributed server and/or database configurations.

A seller terminal 22 and a buyer terminal 24 are each connected to the network 26. The seller terminal 22 and/or buyer terminal 24 can be a computer, telephone, or mobile device, for example, a personal digital assistant (PDA). The seller terminal 22 and/or buyer terminal 24 can be connected to the network 26 by a connection known to those of ordinary skill in the art, for example, a standard telephone line, digital subscriber line, cable, LAN, WAN, broadband, or wireless connection.

The seller terminal 22 and/or the buyer terminal 24 can include components known to those of ordinary skill in the art that permit the seller terminal 22 and the buyer terminal 24 to communicate with each other, and communicate with other elements of the network environment 10, such as the transaction facilitator 14, the electronic marketplace 32, the social network service 34, and/or the e-commerce website 36. These components can include, but not be limited to, a monitor or display, one or more user-input devices, e.g., a keyboard, a mouse, trackball, non-removable non-volatile storage media, for example, hard disks and CD ROMs, and/or other peripheral devices.

In embodiments where the seller terminal 22 and/or the buyer terminal 24 includes a computer, the seller terminal 22 and/or the buyer terminal 24 can include software applications that permit the seller and/or buyer to communicate with other elements of the network environment, such as word processing applications, email client applications, web browsers, and/or other applications that produce and/or transmit electronic communications such as digital messages or other electronic data.

During an on-line transaction, the seller provides from the seller terminal 22 information related to an item to the electronic marketplace 32. The item can be any item of value, including commercial goods, real property, or services. An item of value can have economic value, intrinsic value, and/or personal value. Embodiments herein refer to an item for sale. In other embodiments, items are offered for sale, rent, lease, barter, or offered for free. Item information can include a price, description, location, seller contact information, delivery information, or other relevant information related to the item.

The electronic marketplace 32 provides information on the item. The electronic marketplace 32 can be an on-line auction site, for example, eBay®, or provide on-line classified advertisement website, for example, Craigslist®. The transaction facilitator 14 communicates with the electronic marketplace 32 to receive the item information. Alternatively, the transaction facilitator 14 can receive information related to an item for sale from another information source, such as the e-commerce website 36.

The transaction facilitator 14 identifies one or more potential buyers for the item for sale. Potential buyers can be determined from the same source as the item for sale, for example, the electronic marketplace 32. Potential buyers can also be determined from the e-commerce website 36.

For example, potential buyers can be determined from a wish-list service on the e-commerce website 36. A wish list allows users to inform other users about items they would like to acquire, and provides a way for people to record items they would like to buy or be given. In another example, potential buyers can be determined from a recommendation service on the e-commerce website 36. A recommendation service determines potential buyer interests by examining the items the buyer has purchased, items that the buyer told the recommendation service she owns, items the buyer has rated, and the like. The recommendation service can compare buyer activity on the e-commerce website 36 with that of other customers. Using this comparison, the recommendation service can recommend other items on the e-commerce website 36 that may of interest to the buyer, which can appear elsewhere on the e-commerce website 36, for example, an on-line store.

The transaction facilitator 14 can identify potential buyers in the electronic marketplace 32 who submit bids for an item to an on-line auction, but fail to purchase the item because they are not the highest bidder or for related reasons.

The transaction facilitator 14 can categorize a potential buyer as a qualified potential buyer by determining whether the physical proximity, or geographical proximity, of the potential buyer to the item for sale exceeds a threshold distance. For example, the transaction facilitator 14 can receive item information indicating that an item for sale is located in New York City, and identify two potential buyers: one from Chicago and one from Connecticut. The transaction facilitator 14 can compare each potential buyer to a predetermined threshold distance, for example, 100 miles. In this example, the transaction facilitator 14 determines that the potential buyer from Connecticut is a qualified potential buyer, and that the potential buyer from Chicago is not a qualified potential buyer, or is less qualified than the potential buyer from Connecticut. The threshold distance, or other information items related to geography, can be determined by the seller or by the potential buyers.

The transaction facilitator 14 can cross-reference a potential buyer identified from the electronic marketplace 32 with the e-commerce website 36 to determine whether the potential buyer is a qualified potential buyer. The transaction facilitator 14 can determine from the cross-reference whether the potential buyer submitted a request for the item to a wish list or recommendation service on the e-commerce website 36.

Referring to the previous example, the transaction facilitator 14 identifies a potential buyer from Washington, D.C., who submitted a request for a similar item to a wish list on the e-commerce website 36. Accordingly, this potential buyer can be qualified to receive a notification regarding the item for sale on the electronic marketplace 32.

The transaction facilitator 14 can cross-reference a potential buyer identified from the electronic marketplace 32 with a social network service 34 such as Facebook® or Linkedin® to determine the strength of their relationship, or social proximity, between the potential buyer and the seller. The strength of a relationship between a seller and a buyer can be measured according to “degrees of separation” between the seller and the buyer. The term “six degrees of separation” derives from a well-known social networking concept that each person is six relationships or less from any other person. For example, if a seller and a potential buyer are former college roommates, there is a direct relationship, or first degree of separation, between the seller and potential buyer. In another example, if a potential buyer is a “friend of a friend” of the seller, there is an indirect relationship, more specifically, a second degree of separation, and so on.

The transaction facilitator 14 can also determine from the social networking service 34 if the relationship between the seller and the potential buyer is an acrimonious relationship, whereby the potential buyer is categorized as an unqualified buyer.

Accordingly, in determining the degree of separation between a seller and a potential buyer, the transaction facilitator 14 can compare the actual degree of separation to a threshold degree of separation to determine whether to categorize a potential buyer as a qualified potential buyer. For example, the transaction facilitator 14 can be configured to a threshold second degree of separation. Thus, if the transaction facilitator determines that a potential buyer is a close friend of the seller, i.e., first degree of separation, then the potential buyer can be categorized as a qualified potential buyer. The threshold degree of separation can be determined by the seller or by the potential buyers.

The transaction facilitator 14 generates a notification to each qualified potential buyer of the availability of the item. Sellers can be provided with a list of qualified potential buyers, or other information regarding the potential buyers. For example, the transaction facilitator can send a notification to a potential buyer when an item on her e-commerce site wish list is made available in their local area from a person to whom she has a close relationship.

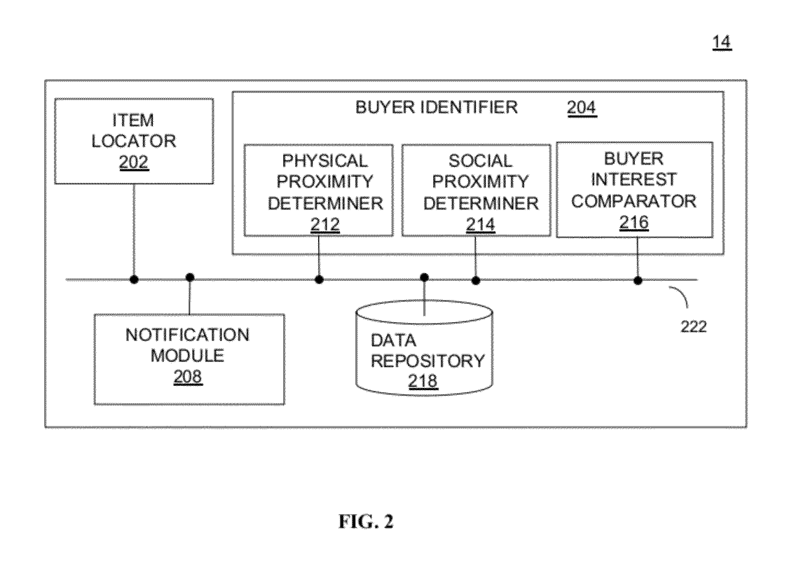

An example configuration of the transaction facilitator 14 is shown in the block diagram of FIG. 2. The transaction facilitator 14 includes an item locator 202, a buyer identifier 204, a notification module 208, and a data repository 218.

The item locator 202, buyer identifier 204, notification module 208, and data repository 218 can be collocated under a single hardware platform, for example, a server system, or can be located on different hardware platforms, and can be in direct communication through a bus 222 or other connector, or in indirect electronic communication with each other, for example, through network 26 shown in FIG. 1.

The item locator 202 identifies an item for availability. The item locator 202 receives information related to the available item from an electronic marketplace 32 such as the eBay® on-line auction, e-commerce website 36, or other source that offers items of value. Item information can include the location of the item. Other item information can include delivery information, for example, whether the buyer can receive the item directly from the seller instead of the seller delivering the item to the buyer.

The buyer identifier 204 can identify one or more potential buyers according to one or more approaches described herein with regard to FIG. 1. The buyer identifier 204 comprises a physical proximity determiner 212 that identifies qualified potential buyers according to their physical proximity to the item for sale and determines whether the potential buyer satisfies a predetermined distance threshold requirement.

The buyer identifier 204 further comprises a social proximity determiner 214 that identifies qualified potential buyers according to their social proximity to the seller. The social proximity determiner 214 communicates with the social network service 34 to determine the degree of separation, i.e., social proximity, between each potential buyer and the seller. The social proximity determiner 214 can identify potential buyers from the social network service 34 and store information received on the potential buyers in a data repository 218. Alternatively, the social proximity determiner 214 can correlate potential buyers identified from other sources such as the electronic marketplace 32 and/or the e-commerce website 36 with social proximity data received from the social network service 34. As a result, new buyers can be added to the list provided by the on-line trade service, or previously identified potential buyers can be qualified to receive a notification regarding the item for availability.

The buyer identifier 204 further comprises a buyer interest comparator 216 that cross-references that potential buyer to a wish-list service, recommendation service, or on-line advertisement service, for example, Craigslist®, or on-line source that captures information related to the potential buyer's buying characteristics or patterns.

Information pertaining to potential buyers can be stored in a data repository 218 for future retrieval by the transaction facilitator 14.

The notification module 208 generates a notification to the potential buyer and/or the seller when the potential buyer is determined to be a qualified potential buyer. In particular, a potential buyer is a qualified potential buyer when the potential buyer is in geographical proximity to the item; for example, the distance between the buyer and the item is less than a predetermined threshold distance. The qualified potential buyer can also be determined to be in social proximity to the seller; for example, if the degree of separation between the seller and buyer is less than a predetermined threshold degree of separation. The qualified potential buyer can also be determined according to previous interests in the item or similar items, for example, according to information collected from e-commerce wish lists, recommendation services, or on-line advertisements. Thus, the notification module 208 can also generate a notification, informing qualified potential buyers when items on their wish list, or items they are interested in, become available in their local area from people they have a relationship with.

The notification module 208 can also generate a notification for the seller. The notification can include information related to one or more qualified potential buyers, such as location information, social relationship information, buyer characteristics, interest level, etc. The notification can include a list of potential buyers that is organized according to distance from the seller, degree of social separation, interest level, or a combination thereof.

Notifications can be generated and sent to a recipient, i.e., the seller and/or the potential buyer, by email, text message, audio message, or other form of on-line communication known to those of ordinary skill in the art. Notifications can also be posted on the buyer's personal account on the e-commerce website 36.

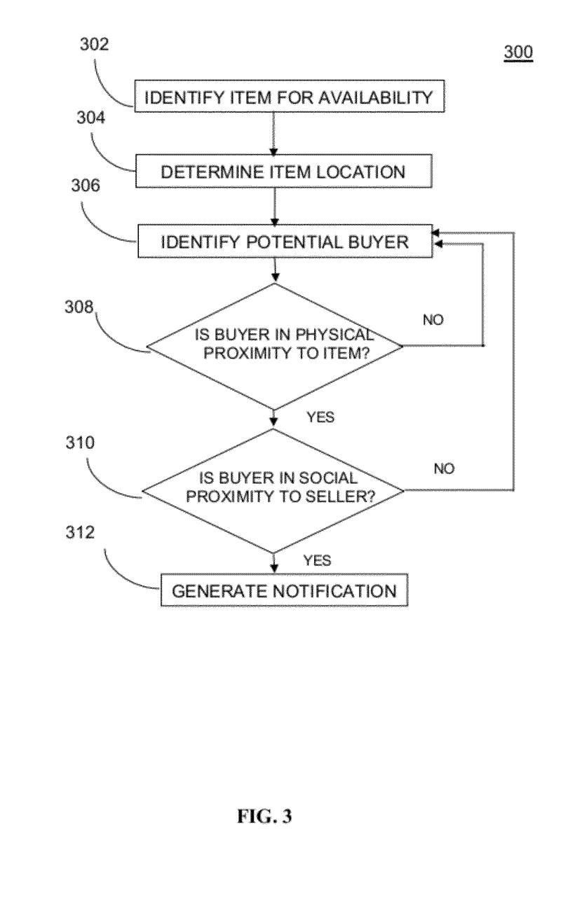

FIG. 3 is a flowchart showing an embodiment of a method 300 for facilitating a commercial transaction between a buyer and a seller over a communications network. Some or all of the method 300 can be performed on the transaction facilitator 14 described with reference to FIGS. 1 and 2.

The method commences at step 302 with an item identified for acquisition by a buyer, for example, the item is available for sale. The item can be identified from an electronic marketplace, e-commerce website such as an on-line retailer website, or on-line classified advertisement website.

The item location is determined (step 304). The item location can be determined from the same source as the item, for example, an electronic marketplace, e-commerce website, or determined from another information source. Other item information can be determined, such as whether the buyer can obtain the item directly from the seller.

A potential buyer is identified (step 306). The potential buyer can be identified from the same source as the item availability, for example, an electronic marketplace, e-commerce website, or other information source. The potential buyer can be identified from other sources, for example, an on-line database, an on-line retailer website such as Amazon®, a social network service such as Facebook® or Linkedin®, an on-line classified advertisement website such as Craigslist®, or a local directory, such as a lightweight directory access protocol (LDAP) server.

The potential buyer is determined (step 308) whether to be in geographical proximity to the item (step 308). This can be achieved by comparing the actual distance from the potential buyer to the item to a predetermined threshold. For example, if the predetermined threshold distance is 50 miles and the actual distance is 70 miles, then the method proceeds back to step 306, where another potential buyer is identified. In another example, if the predetermined threshold distance is 50 miles and the actual distance is 40 miles, then the method proceeds to step 310, where the potential buyer is determined whether to be in social proximity to the seller.

The potential buyer is determined (step 310) to be in social proximity to the seller by comparing the degree of relationship of the seller and potential buyer to a predetermined threshold. For example, if the predetermined threshold is two degrees of separation, and the actual relationship is determined to be one degree of separation, for example, co-workers, then the potential buyer is qualified as being in social proximity to the seller. In an embodiment, the potential buyer is first determined to be in physical proximity to the item, then determined whether to be in social proximity to the seller. In another embodiment, the potential buyer is first determined to be in social proximity to the seller, then determined whether to be in physical proximity to the item.

A notification is generated (step 312) if the potential buyer is determined to be in physical proximity to the available item and the potential buyer is determined to be in social proximity to the seller. A notification can be sent to the potential buyer, information the potential buyer of the available item, as well as other information related to the item, for example, whether the buyer can receive the item directly from the seller.

A notification can be sent to the seller of the item, informing the seller of the potential buyer. The notification can include additional information, such as the potential buyer's recent wish list request for the item. The notification to the seller can include a list of qualified potential buyers that are categorized according to physical proximity, social proximity, and/or interest level.

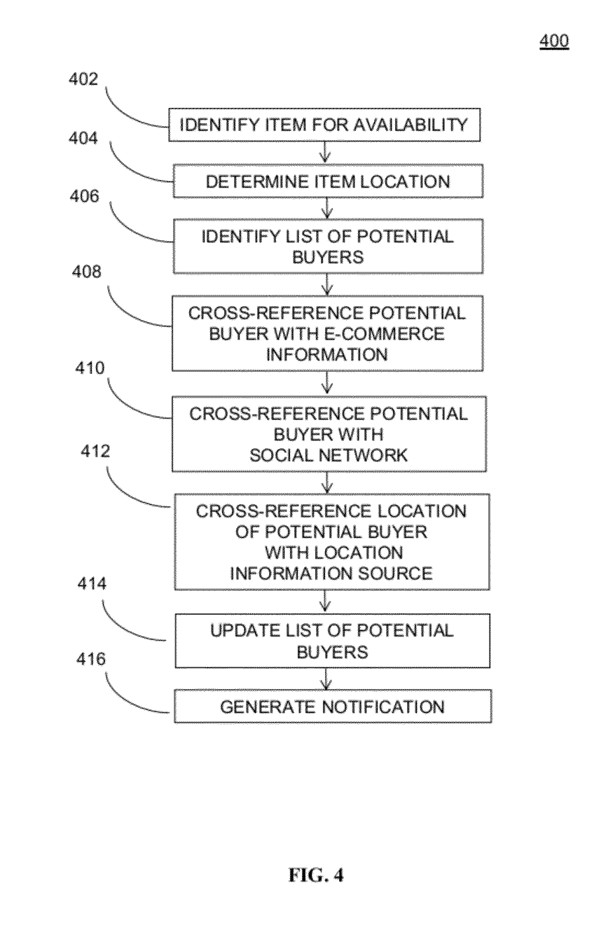

FIG. 4 is a flowchart showing an embodiment of another method 400 for facilitating an on-line transaction between a buyer and a seller. Some or all of the method 400 can be performed on the transaction facilitator 14 described with reference to FIGS. 1 and 2. The method 400 can be performed when a potential buyer changes locations; for example, the potential buyer moves into the region of physical proximity to an item for sale, or leaves a region of physical proximity to the item.

The method commences at step 402 with identifying an item for acquisition by a buyer, for example, the item is available for sale. The item can be identified from an electronic marketplace, e-commerce website such as an on-line retailer, or on-line classified advertisement website.

The item location is determined (step 404). The item location can be determined from the same source as the item, for example, an electronic marketplace, e-commerce website, or determined from another information source. Other item information can be determined, such as whether the buyer can pick the item up directly at the seller's location.

One or more potential buyers are identified (step 406) as being interested in the available item. The potential buyers can be identified in a similar manner as that described above with regard to FIGS. 1-3, for example, an electronic marketplace, e-commerce website, or other information source.

A potential buyer of the one or more potential buyers is cross-referenced (step 408) with e-commerce information provided by a wish list service, recommendation service, or other e-commerce source.

The potential buyer is cross-referenced (step 410) with a social network service to determine the strength of the relationship between the seller and the potential buyer. The strength of the relationship between the seller and the potential buyer can be determined according to approaches described herein, for example, by determining a degree of separation between the seller and the potential buyer.

The location of the potential buyer as identified by information provided by an electronic marketplace or e-commerce website is cross-referenced (step 412) with a location information source such as the Dopplr® service, or other on-line service where people share travel plans. The cross-reference is performed to determine whether the potential buyer is no longer in physical proximity to the item. For example, if a potential buyer is identified initially as being in New York City, and an item for sale is determined to be in Connecticut, then the location of the potential buyer can be updated when a cross-reference to a location information source determines that the buyer moved to Chicago.

The list of potential buyers can be updated (step 414) to add or remove potential buyers based on a change in location, or based on other cross-reference results.

A notification is generated (step 416) according to the updated list of potential buyers. The notification can be sent to the potential buyer and/or the seller of the item in a format known to those of ordinary skill in the art, for example, an email message.

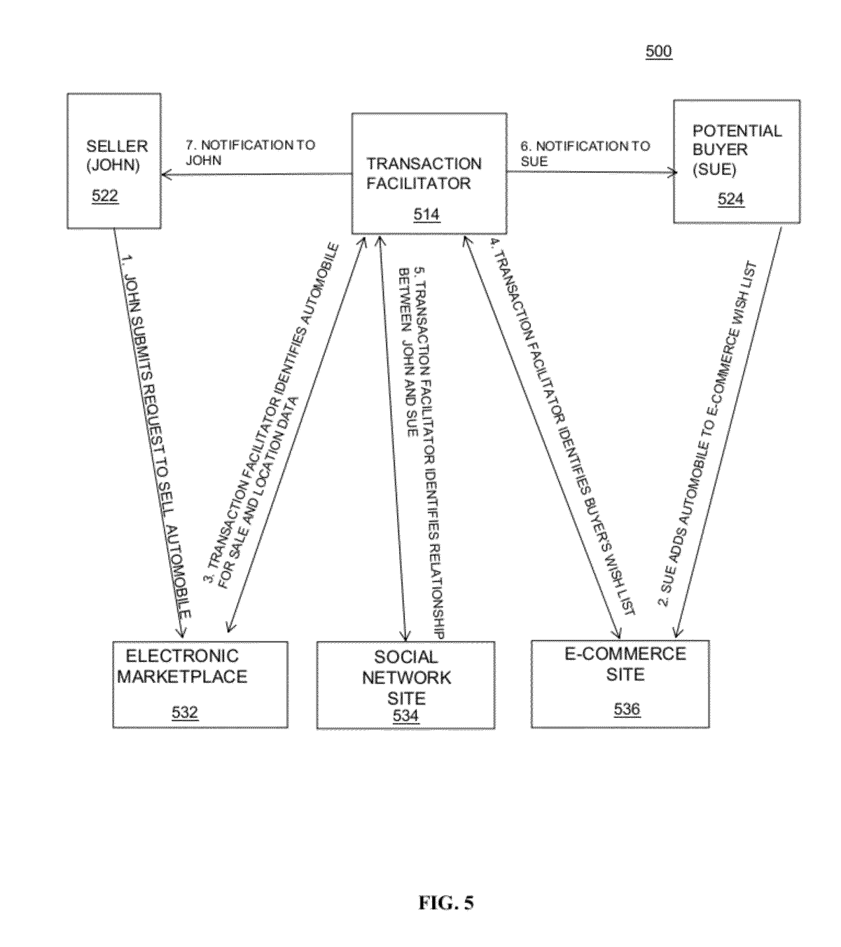

FIG. 5 is a schematic block diagram illustrating an example of an embodiment of a process flow 500 for a transaction facilitator 514.

In this illustrative example, a seller 522, John, submits a request to an electronic marketplace 532 such as eBay® to sell his automobile. A prospective buyer 524, Sue, sends a wish list request to an e-commerce site 536 such as Amazon® that she would like to own an automobile similar to the automobile for sale.

A transaction facilitator 514 discovers that John would like to sell his automobile by querying the electronic marketplace 532. The transaction facilitator 514 also queries the e-commerce site 536, and identifies Sue as a potential buyer from her wish list request. The transaction facilitator 514 also queries a social network site 534 such as Facebook® and determines that Sue and John have a first degree relationship, in particular, Sue and John are close friends.

The transaction facilitator 514 sends a notification to the prospective buyer 524, Sue, that her friend John is selling his automobile. The transaction facilitator 514 sends a notification to the seller 522, John, that his friend Sue is interested in purchasing an automobile.

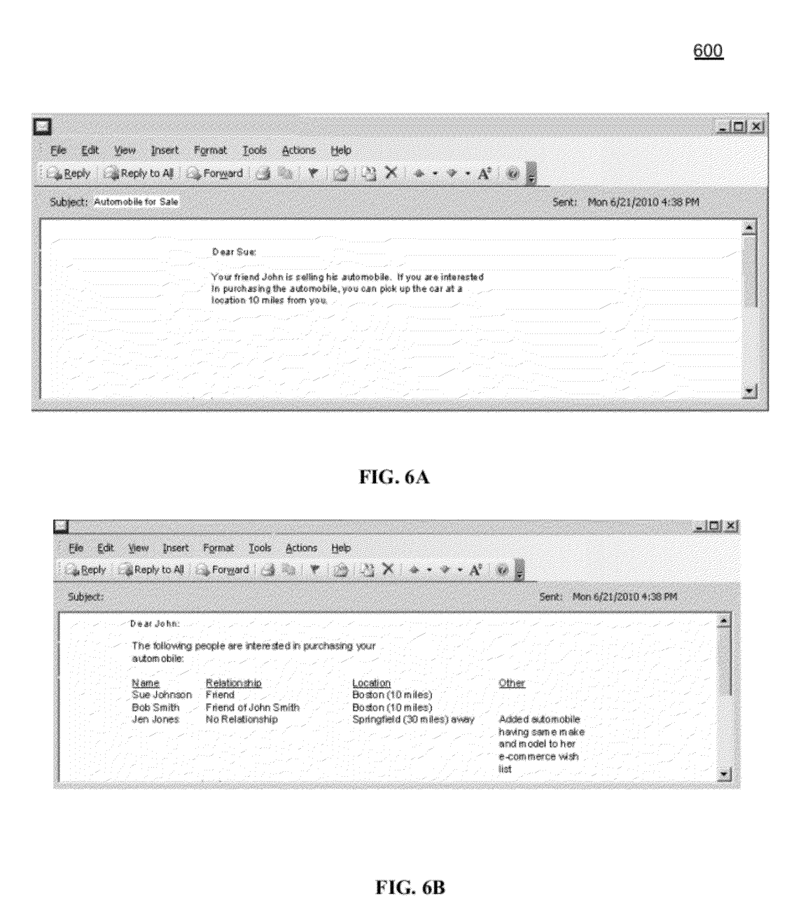

FIG. 6 is a screenshot of an embodiment of a notification 600 to a potential buyer of an item for purchase. The notification 600 can be similar to the notification generated by the transaction facilitator 514, and sent to the buyer 524, Sue, shown in FIG. 5. The notification 600 can include information that is useful to the potential buyer in making a decision as to whether to purchase the item. Such information can include item location details, such as address, distance from the buyer, etc. Such information can include social network information such as the relationship between the potential buyer and the seller.

FIG. 6B is a screenshot of an embodiment of a notification 700 to a seller of an item. The notification 700 can be similar to the notification generated by the transaction facilitator 514, and sent to the seller 522, John, shown in FIG. 5. The notification 700 can include a list of prospective buyers, and information pertaining to each prospective buyer. The notification 600 can include information that is useful to the seller in making a decision as to the potential buyer to whom he is interested in selling his item. Such information can include buyer location details, such as address, distance from the seller, etc. Such information can include social network information such as the relationship between the potential buyer and the seller. Such information can include information regarding a level of interest in the item by the prospective buyer, for example, as indicated on-line requests, for example, wish-list entries, to purchase the item, etc.

While the invention has been shown and described with reference to specific embodiments, it should be understood by those skilled in the art that various changes in form and detail may be made therein without departing from the spirit and scope of the invention.

What is claimed is:

1. A computer-implemented method for facilitating an on-line transaction, the method comprising:
receiving an information item from an on-line location, the information item related to an available item;
identifying a potential recipient of the available item;
qualifying the potential recipient for notification of the available item by determining a physical proximity between the available item and an offeror of the item;
qualifying the potential recipient for notification of the available item by determining a relationship between the offeror of the item and the potential recipient; and
generating an electronic notification for the qualified potential recipient in response to the physical proximity determination and the relationship determination.

2. The computer-implemented method of claim 1, wherein the potential recipient is a potential buyer of the available item and the offeror is a seller of the item.

3. The computer-implemented method of claim 2, the seller and the potential buyer perform the on-line transaction in response to receipt by at least one of the seller and the potential buyer of the generated electronic notification.

4. The computer-implemented method of claim 1, wherein the electronic notification informs the offeror of the potential recipient.

5. The computer-implemented method of claim 1, wherein the information item includes at least one of a location of the available item, item delivery information, and seller information.

6. The computer-implemented method of claim 1, wherein the on-line location is at least one of an electronic marketplace, a social network website, and an e-commerce website.

7. The computer-implemented method of claim 6, wherein the information item is received from the electronic marketplace and the prospective recipient is identified from the electronic marketplace.

8. The computer-implemented method of claim 1 further comprising qualifying the potential recipient by cross-referencing information related to the potential recipient with at least one of an e-commerce wish list, an e-commerce recommendation service, and an on-line advertisement service to determine if the potential recipient has an interest in the item.

9. The computer-implemented method of claim 1 further comprising:
comparing the potential recipient and a location information source to determine a current location of the potential recipient; and
qualifying the potential recipient for notification of the available item in response to the comparison of the potential recipient and the location information source.

10. The computer-implemented method of claim 1, wherein determining the physical proximity between the available item and the offeror of the item comprises comparing the geographical distance between the potential recipient and the available item and a threshold distance.

11. The computer-implemented method of claim 1, wherein determining the social proximity between the offeror of the item and the potential recipient comprises comparing a degree of separation between the offeror and the potential recipient of the available item and a threshold degree of separation.

12. The computer-implemented method of claim 1, wherein the notification includes at least one of the availability of the item from the on-line location, item delivery information, and offeror availability information.

13. The computer-implemented method of claim 1 further comprising generating an electronic notification for the offeror to inform the offeror of the potential recipient.

14. A transaction facilitator comprising:
an item locator that receives an information item from an on-line location, the information item related to an available item;
a buyer identifier that identifies a potential recipient of the available item, the buyer identifier further qualifying the potential recipient for notification of the available item by determining a physical proximity between the available item and an offeror of the item and by determining a relationship between the offeror of the item and the potential recipient; and
a notification module that generates an electronic notification for the qualified potential recipient in response to the physical proximity determination and the relationship determination.

15. The transaction facilitator of claim 14, wherein the buyer identifier comprises:
a physical proximity determiner that compares the actual distance between the potential recipient and the available item and a threshold distance; and
a social proximity determiner that compares the degree of separation between the offeror and the potential recipient and the available item and a threshold degree of separation.

16. The transaction facilitator of claim 14, wherein the buyer identifier comprises a buyer interest comparator that compares information related to the potential recipient and at least one of an e-commerce wish list, an e-commerce recommendation service, and an on-line advertisement service to determine whether the potential recipient has an interest in the item.

17. The transaction facilitator of claim 14, wherein the buyer interest comparator compares the potential recipient and a location information source to determine a current location of the potential recipient, and wherein the buyer identifier qualifies the potential recipient for notification of the available item in response to the comparison between the potential recipient and the location information source.

18. The transaction facilitator of claim 14, wherein the potential recipient is a potential buyer of the available item and the offeror is a seller of the item.

19. The transaction facilitator of claim 14, wherein the on-line location is at least one of an electronic marketplace, a social network website, and an e-commerce website.

20. A computer program product for notification of availability of an item, the computer program product comprising:
a computer readable storage medium having computer readable program code embodied therewith, the computer readable program code comprising:
computer readable program code configured to receive an information item from an on-line location, the information item related to an available item;
computer readable program code configured to identify a potential recipient of the available item;
computer readable program code configured to qualify the potential recipient for notification of the available item by determining a physical proximity between the available item and an offeror of the available item;
computer readable program code configured to qualify the potential recipient for notification of the available item by determining a social proximity between the offeror of the item and the potential recipient; and
computer readable program code configured to generate an electronic notification for the qualified potential recipient in response to the physical proximity determination and the social proximity determination.
